(19) United States
(12) Patent Application Publication
(10) Pub. No.: US 2026/0238757 A1
(43) Pub. Date: Aug. 13, 2026

(54) INTER-PREDICTION-BASED IMAGE ENCODING/DECODING METHOD AND DEVICE, AND RECORDING MEDIUM FOR STORING BITSTREAMS

(71) Applicant: INTELLECTUAL DISCOVERY CO., LTD., Seoul (KR)

(72) Inventors: Jongseok LEE, Seoul (KR); Min Sub KIM, Seoul (KR)

(21) Appl. No.: 19/149,209

(22) PCT Filed: Jan. 17, 2024
(86) PCT No.: PCT/KR2024/000869

§ 371 Date: Jul. 18, 2025

(30) Foreign Application Priority Data
Jan. 19, 2023 (KR) 10-2023-0008244
Feb. 9, 2023 (KR) 10-2023-0017471

(51) Int. Cl. H04N 19/105; H04N 19/159; H04N 19/176; H04N 19/577

(52) U.S. Cl. CPC H04N 19/105; H04N 19/159; H04N 19/176; H04N 19/577

(57) ABSTRACT

An image decoding/encoding method and device disclosed herein may: determine a co-located block for temporal motion vector prediction of the current block; derive a block vector from the co-located block; derive a motion vector of the current block on the basis of the block vector; and generate a prediction signal of the current block by performing inter-prediction on the basis of the motion vector of the current block.

### TECHNICAL FIELD

The present invention relates to an encoder and a decoder, and more particularly, relates to a method and an apparatus for video encoding and decoding.

### BACKGROUND ART

As the market demand for high-resolution videos has increased, a technology which may effectively compress high-resolution images is necessary. According to this market demand, MPEG (Moving Picture Expert Group) of ISO/IEC and VCEG (Video Coding Expert Group) of ITU-T jointly formed JCT-VC (Joint Collaborative Team on Video Coding) to develop HEVC (High Efficiency Video Coding) video compression standards on January 2013 and has actively conducted research and development for next-generation compression standards.

The video compression is largely composed of intra prediction, inter prediction, transform, quantization, entropy coding and an in-loop filter. Meanwhile, as the demand for high-resolution images has increased, the demand for stereo-scopic image contents has increased together as a new image service. A video compression technology for effectively providing high-resolution and ultra high-resolution stereo-scopic image contents is being discussed.

### DISCLOSURE

### Technical Problem

The present disclosure provides an inter prediction method and apparatus through temporal motion vector prediction.

The present disclosure provides a geometric partitioning-based prediction method and apparatus.

### Technical Solution

A decoding method and apparatus according to the present disclosure may determine a co-located block for temporal motion vector prediction of a current block, derive a block vector from the co-located block, derive a motion vector of the current block based on the block vector, and generate a prediction signal of the current block by performing inter prediction based on the motion vector of the current block.

In a decoding method and apparatus according to the present disclosure, the co-located block may be a block encoded in an intra block copy (IBC) mode.

In a decoding method and apparatus according to the present disclosure, the co-located block may be a block encoded in a template matching-based intra mode.

In a decoding method and apparatus according to the present disclosure, the block vector may be derived based on a position difference between the co-located block and a reference block for template matching of the co-located block.

In a decoding method and apparatus according to the present disclosure, a reference picture of the current block may be substituted with a co-located picture to which the co-located block belongs.

In a decoding method and apparatus according to the present disclosure, the motion vector of the current block may be derived by applying a predetermined scaling factor to the block vector. Here, a scaling factor may be derived based on at least one of a first POC difference between a current picture to which the current block belongs and the reference picture of the current block or a second POC difference between the co-located picture to which the co-located block belongs and the reference picture of the current block.

An encoding method and apparatus according to the present disclosure may determine a co-located block for temporal motion vector prediction of a current block, derive a block vector from the co-located block, derive a motion vector of the current block based on the block vector, and generate a prediction signal of the current block by performing inter prediction based on the motion vector of the current block.

A computer readable digital storage medium is provided in which encoded video/image information that causes a decoding apparatus according to the present disclosure to perform an image decoding method is stored.

A computer readable digital storage medium is provided in which video/image information generated according to an image encoding method according to the present disclosure is stored.

A method and an apparatus for transmitting video/image information generated according to an image encoding method according to the present disclosure are provided.

### Technical Effect

The encoding efficiency of inter prediction may be improved through temporal motion vector prediction according to the present disclosure.

The encoding efficiency of geometric partitioning information may be improved through prediction of geometric partitioning information according to the present disclosure, and the accuracy of prediction may be improved through more accurate geometric partitioning.

### BRIEF DESCRIPTION OF DRAWINGS

FIG. 1 is a block diagram showing an image encoding apparatus according to the present invention.

FIG. 2 is a block diagram showing an image decoding apparatus according to the present invention.

FIG. 3 shows a method for performing inter prediction based on temporal motion vector prediction according to the present disclosure.

FIG. 4 shows a method for performing inter prediction based on temporal motion vector prediction when a co-located block is a block encoded in an IBC mode.

FIG. 5 shows a method for performing inter prediction based on temporal motion vector prediction when a co-located block is a block encoded in an IBC mode.

FIG. 6 shows a geometric partitioning-based prediction method according to the present disclosure.

FIG. 7 shows a method for predicting geometric partitioning information according to the present disclosure.

FIG. 8 shows a method for predicting geometric partitioning information according to the present disclosure.

FIG. 9 shows a method for predicting geometric partitioning information according to the present disclosure.

FIG. 10 shows a method for deriving geometric partitioning information according to the present disclosure.

FIG. 11 shows a method for deriving geometric partitioning information according to the present disclosure.

FIG. 12 shows a method for predicting geometric partitioning information according to the present disclosure.

### MODE FOR INVENTION

Referring to drawings attached to this specification, the embodiment of the present invention will be described in detail so that those skilled in the art may easily implement it in the technical field to which the present invention belongs. However, the present invention may be implemented in different forms and is not limited to embodiments described herein. In addition, in order to clearly explain the present invention in drawings, parts that are not related to the description are omitted, and similar drawing signs are attached to similar parts throughout the specification.

Throughout this specification, when a part is referred to as being ‘connected to’ another part, it includes not only a case where it is directly connected, but also a case where it is electrically connected with other elements in between.

In addition, throughout this specification, when a part is referred to as ‘including’ a component, it means that instead of excluding other components, other components may be further included, unless otherwise specifically opposed.

In addition, although terms ‘first’, ‘second’, etc. may be used to describe various components, the components should not be limited by the terms. The terms are used only to distinguish one component from other components.

In addition, in an embodiment regarding a device and a method described in this specification, some configurations of the device or some steps of the method may be omitted. In addition, the order of some configurations of the device or some steps of the method may be changed. In addition, another configuration or another step may be inserted in some configurations of the device or some steps of the method.

In addition, some configurations or some steps in the first embodiment of the present disclosure may be added to the second embodiment of the present disclosure or may be replaced with some configurations or some steps in the second embodiment.

In addition, as construction units shown in an embodiment of the present disclosure are independently shown to represent different characteristic functions, it does not mean that each construction unit is composed in a construction unit of separate hardware or one software. In other words, as each construction unit is described by being enumerated as each construction unit for convenience of a description, at least two construction units of each construction unit may be combined to form one construction unit or one construction unit may be divided into a plurality of construction units to perform a function. The integrated embodiment and separate embodiment of each construction unit are also included in a scope of a right of the present disclosure unless they are beyond the essence of the present disclosure.

First, terms used herein are briefly described as follows.

A video decoding apparatus described below may be an apparatus included in a server terminal such as a civil security camera, a civil security system, a military security camera, a military security system, a personal computer (PC), a laptop computer, a portable multimedia player (PMP), a wireless communication terminal, a smart phone, a TV application server, a service server, etc., and may refer to various apparatus including a user terminal such as various devices, a communication apparatus such as a communication modem, etc. for communicating with a wired or wireless communication network, a memory for storing various programs and data for decoding an image or performing inter or intra prediction for decoding and a microprocessor for executing a program and calculating and controlling the program.

In addition, an image encoded into a bitstream by an encoder may be transmitted to an image decoding apparatus through a wired or wireless communication network such as the Internet, a wireless local area network, a wireless LAN network, a wibro network, a mobile communication network, etc. or through various communication interfaces such as a cable, a universal serial bus (USB), etc. in real time or non-real time and may be decoded, reconstructed and played back as an image. Alternatively, a bitstream generated by an encoder may be stored in a memory. The memory may include both a volatile memory and a nonvolatile memory. In this specification, a memory may be expressed as a recording medium storing a bitstream.

Typically, a video may be composed of a series of pictures, and each picture may be partitioned into coding units such as blocks. In addition, those skilled in the art to which this embodiment belongs will understand that a term of ‘picture’ described below may be used by being substituted with other terms having the equivalent meaning such as ‘image’, ‘frame’, etc. And, those skilled in the art to which this embodiment belongs will understand that a term of ‘coding unit’ may be used by being substituted with other terms having the equivalent meaning such as ‘unit block’, ‘block’, etc.

Hereinafter, the embodiment of the present invention will be described in more detail by referring to attached drawings. In describing the present invention, the overlapping description of the same components is omitted.

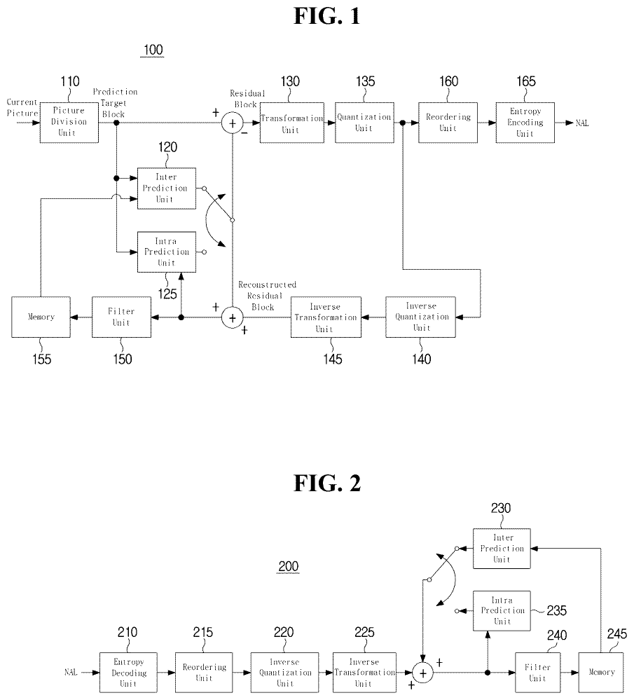

FIG. 1 is a block diagram showing an image encoding apparatus according to the present invention.

In reference to FIG. 1, a conventional image encoding apparatus 100 may include a picture division unit 110, prediction units 120 and 125, a transformation unit 130, a quantization unit 135, a reordering unit 160, an entropy encoding unit 165, an inverse quantization unit 140, an inverse transformation unit 145, a filter unit 150 and a memory 155.

A picture division unit 110 may partition an input picture in at least one processing unit. In this case, a processing unit may be a prediction unit(PU), a transform unit(TU) or a coding unit(CU). Hereinafter, in the embodiment of the present disclosure, a coding unit may be used as a unit performing encoding or may be used as a unit performing decoding.

A prediction unit may be partitioned in at least one square or rectangular shape, etc. with the same size within one coding unit, or may be partitioned so that any one prediction unit among the prediction units partitioned in one coding unit has a shape and/or a size different from another prediction unit. When it is not a minimum coding unit in generating a prediction unit which performs intra prediction based on a coding unit, intra prediction may be performed without being partitioned into a plurality of prediction units, N×N.

Prediction units 120 and 125 may include an inter prediction unit 120 performing inter prediction or inter prediction and an intra prediction unit 125 performing intra prediction or intra prediction. Whether to perform inter prediction or intra prediction for a prediction unit may be determined, and specific information according to each prediction method (e.g., an intra prediction mode, a motion vector, a reference picture, etc.) may be determined. A residual value (a residual block) between a generated prediction block and an original block may be input into a transformation unit 130. In addition, prediction mode information, motion vector information, etc. used for prediction may be encoded in an entropy encoding unit 165 with a residual value and transmitted to a decoder. However, when a decoder-side motion information derivation technique according to the present invention is applied, the prediction mode information, the motion vector information, etc. are not generated in an encoder, so corresponding information is not transmitted to a decoder. On the other hand, the encoder may signal and transmit information indicating that motion information is derived and used on a decoder side and information on a technique used to derive the motion information.

An inter prediction unit 120 may predict a prediction unit based on information of at least one picture of a previous picture or a subsequent picture of a current picture, or may predict a prediction unit based on information of some regions which are encoded within a current picture in some cases. An inter prediction unit 120 may include a reference picture interpolation unit, a motion prediction unit and a motion compensation unit.

In a reference picture interpolation unit, reference picture information may be provided from a memory 155 and pixel information equal to or less than an integer pixel may be generated in a reference picture. For a luma pixel, a DCT-based 8-tap interpolation filter with a different filter coefficient may be used to generate pixel information equal to or less than an integer pixel in a ¼-pixel unit. For a chroma signal, a DCT-based 4-tap interpolation filter with a different filter coefficient may be used to generate pixel information equal to or less than an integer pixel in a ⅛-pixel unit.

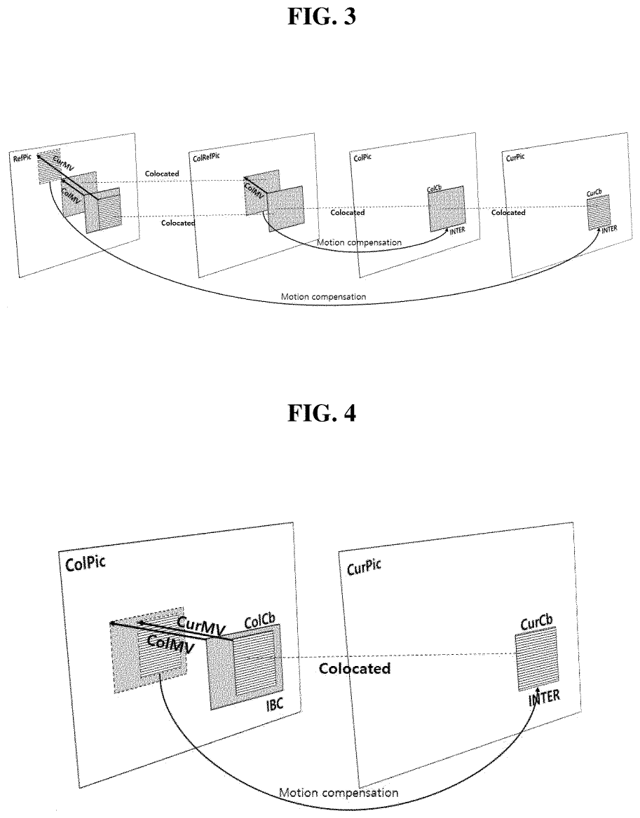

A motion prediction unit may perform motion prediction based on a reference picture interpolated by a reference picture interpolation unit. As a method for calculating a motion vector, various methods such as FBMA (Full search-based Block Matching Algorithm), TSS (Three Step Search), NTS (New Three-Step Search Algorithm), etc. may be used. A motion vector may have a motion vector value in a ½ or ¼-pixel unit based on an interpolated pixel. In a motion prediction unit, a current prediction unit may be predicted by making a motion prediction method different. As a motion prediction method, various methods such as a skip mode, a merge mode, an Advanced Motion Vector Prediction (AMVP) mode, an intra block copy mode, etc. may be used. In addition, in applying a decoder-side motion information derivation technique according to the present invention, a template matching method and a bilateral matching method utilizing motion trajectory may be applied as a method performed in a motion prediction unit. In this regard, the template matching method and the bilateral matching method will be described in detail below in FIG. 3.

An intra prediction unit 125 may generate a prediction unit based on reference pixel information around a current block, which is pixel information within a current picture. When a reference pixel is a pixel which performed inter prediction because a neighboring block in a current prediction unit is a block which performed inter prediction, a reference pixel included in a block which performed inter prediction may be used by being substituted with reference pixel information of a neighboring block which performed intra prediction. In other words, when a reference pixel is unavailable, unavailable reference pixel information may be used by being substituted with at least one reference pixel of the available reference pixels.

In addition, a residual block including residual value information, which is a difference value between a prediction unit which performed prediction based on a prediction unit generated in prediction units 120 and 125 and an original block in a prediction unit, may be generated. A generated residual block may be input into a transformation unit 130.

In a transformation unit 130, an original block and a residual block including residual value information in a prediction unit generated through prediction units 120 and 125 may be transformed by using a transform method such as Discrete Cosine Transform (DCT), Discrete Sine Transform (DST) and KLT. Whether to apply DCT, DST or KLT to transform a residual block may be determined based on intra prediction mode information in a prediction unit used to generate a residual block.

A quantization unit 135 may quantize values which are transformed into a frequency domain in a transformation unit 130. According to a block or according to the importance of an image, a quantization coefficient may be changed. A value calculated in a quantization unit 135 may be provided to an inverse quantization unit 140 and a reordering unit 160.

A reordering unit 160 may perform rearrangement of a coefficient value for a quantized residual value.

A reordering unit 160 may change a two-dimensional block-shaped coefficient into a one-dimensional vector shape through a coefficient scanning method. For example, in a reordering unit 160, a DC coefficient to a coefficient in a high frequency domain may be scanned by a zig-zag scan method and changed into a one-dimensional vector shape. A vertical scan which scans a two-dimensional block-shaped coefficient in a column direction or a horizontal scan which scans a two-dimensional block-shaped coefficient in a row direction may be used instead of a zig-zag scan according to a size in a transform unit and an intra prediction mode. In other words, which scan method among a zig-zag scan, a vertical scan and a horizontal scan will be used according to a size in a transform unit and an intra prediction mode may be determined.

An entropy encoding unit 165 may perform entropy encoding based on values calculated by a reordering unit 160. For example, entropy encoding may use various encoding methods such as Exponential Golomb, CAVLC (Context-Adaptive Variable Length Coding) and CABAC (Context-Adaptive Binary Arithmetic Coding). In this regard, an entropy encoding unit 165 may encode residual value coefficient information in a coding unit from a reordering unit 160 and prediction units 120 and 125. In addition, according to the present invention, it is possible to signal and transmit information indicating that motion information is derived and used on a decoder side and information on a technique used to derive motion information.

In an inverse quantization unit 140 and an inverse transformation unit 145, values quantized in a quantization unit 135 are dequantized and values transformed in a transformation unit 130 are inversely transformed. A residual value generated in an inverse quantization unit 140 and an inverse transformation unit 145 may generate a reconstructed block by being combined with a prediction unit which is predicted through a motion estimation unit, a motion compensation unit and an intra prediction unit included in prediction units 120 and 125.

A filter unit 150 may include at least one of a deblocking filter, an offset modification unit or an adaptive loop filter (ALF). A deblocking filter may remove block distortion generated due to a boundary between blocks in a reconstructed picture. An offset modification unit may modify an offset with an original image in a pixel unit for an image that performed deblocking. A method in which a pixel included in an image is divided into a certain number of regions, a region which will perform an offset is determined and an offset is applied to a corresponding region or a method in which an offset is applied by considering edge information of each pixel may be used to perform offset modification for a specific picture. Adaptive Loop Filtering (ALF) may be performed based on a value obtained by comparing a filtered reconstructed image with an original image. A pixel included in an image may be divided into predetermined groups and one filter which will be applied to a corresponding group may be determined to perform filtering discriminately for each group.

A memory 155 may store a reconstructed block or picture calculated through a filter unit 150, and a stored reconstructed block or picture may be provided to prediction units 120 and 125 when inter prediction is performed.

FIG. 2 is a block diagram showing an image decoding apparatus according to the present invention.

Referring to FIG. 2, an image decoder 200 may include an entropy decoding unit 210, a reordering unit 215, an inverse quantization unit 220, an inverse transformation unit 225, prediction units 230 and 235, a filter unit 240 and a memory 245.

When an image bitstream is input from an image encoder, an input bitstream may be decoded in a process opposite to that of an image encoder.

An entropy decoding unit 210 may perform entropy decoding in a process opposite to a process in which entropy encoding is performed in the entropy encoding unit of an image encoder. For example, in response to a method performed in an image encoder, various methods such as Exponential Golomb, CAVLC (Context-Adaptive Variable Length Coding) and CABAC (Context-Adaptive Binary Arithmetic Coding) may be applied.

In an entropy decoding unit 210, information related to intra prediction and inter prediction performed in an encoder may be decoded.

A reordering unit 215 may perform rearrangement based on a method in which a bitstream entropy-decoded in an entropy decoding unit 210 is rearranged in an encoding unit. Coefficients represented in a one-dimensional vector shape may be reconstructed and rearranged into coefficients in a two-dimensional block shape.

An inverse quantization unit 220 may perform dequantization based on a quantization parameter provided in an encoder and the coefficient value of a rearranged block.

An inverse transformation unit 225 may perform transform performed in a transform unit for a result of quantization performed in an image encoder, i.e., inverse transform for DCT, DST and KLT, i.e., inverse DCT, inverse DST and inverse KLT. Inverse transform may be performed based on a transmission unit determined in an image encoder. In the inverse transformation unit 225 of an image decoder, a transform technique (e.g., DCT, DST, KLT) may be selectively performed according to a plurality of information such as a prediction method, the size of a current block, a prediction direction, etc.

The prediction units 230 and 235 may generate a prediction block based on information related to prediction block generation provided in an entropy decoding unit 210 and pre-decoded block or picture information provided in a memory 245.

As described above, when the size of a prediction unit is the same as that of a transform unit in performing intra prediction or intra prediction in the same manner as an operation in an image encoder, intra prediction for a prediction unit is performed based on a pixel at the left position of a prediction unit, a pixel at a top-left position and a pixel at a top position, but when the size of a prediction unit is different from that of a transform unit in performing intra prediction, intra prediction may be performed by using a reference pixel based on a transform unit. In addition, intra prediction using N×N partition may be used only for a minimum coding unit.

The prediction units 230 and 235 may include a prediction unit determination unit, an inter prediction unit and an intra prediction unit. A prediction unit determination unit may receive a variety of information such as prediction unit information, prediction mode information of an intra prediction method, information related to motion prediction of an inter prediction method, etc. which are input from an entropy decoding unit 210, divide a prediction unit in a current coding unit and determine whether a prediction unit performs inter prediction or intra prediction. On the other hand, when an encoder 100 transmits information indicating that motion information is derived and used on a decoder side and information on a technique used to derive motion information without transmitting motion prediction-related information for the inter prediction, the prediction unit determination unit determines whether an inter prediction unit 23 performs prediction based on information transmitted from an encoder 100.

An inter prediction unit 230 may perform inter prediction on a current prediction unit based on information included in at least one picture of a previous picture or a subsequent picture of a current picture including a current prediction unit by using information necessary for inter prediction in a current prediction unit provided from an image encoder. In order to perform inter prediction, whether a motion prediction method in a prediction unit included in a corresponding coding unit is a skip mode, a merge mode, a AMVP mode or an intra block copy mode may be determined based on a coding unit. Alternatively, an inter prediction unit 230 may perform inter prediction by autonomously deriving motion information from information indicating that motion information is derived and used on a decoder side and information on a technique used to derive motion information which are provided from the image encoder.

An intra prediction unit 235 may generate a prediction block based on pixel information within a current picture. When a prediction unit is a prediction unit that performed intra prediction, intra prediction may be performed based on intra prediction mode information in a prediction unit provided from an image encoder. An intra prediction unit 235 may include an adaptive intra smoothing (AIS) filter, a reference pixel interpolation unit and a DC filter. An AIS filter is a part for performing filtering on the reference pixel of a current block, which may be applied by determining whether a filter is applied according to a prediction mode in a current prediction unit. AIS filtering may be performed on the reference pixel of a current block by using AIS filter information and a prediction mode in a prediction unit provided from an image encoder. When the prediction mode of a current block is a mode that does not perform AIS filtering, an AIS filter may not be applied.

When a prediction mode in a prediction unit is a prediction unit that performs intra prediction based on a pixel value interpolating a reference pixel, a reference pixel interpolation unit may interpolate a reference pixel to generate a reference pixel in a pixel unit equal to or less than an integer value. When a prediction mode in a current prediction unit is a prediction mode that generates a prediction block without interpolating a reference pixel, a reference pixel may not be interpolated. A DC filter may generate a prediction block through filtering when the prediction mode of a current block is a DC mode.

A reconstructed block or picture may be provided to a filter unit 240. A filter unit 240 may include a deblocking filter, an offset modification unit and an ALF.

Information on whether a deblocking filter is applied to a corresponding block or picture and information on whether a strong filter or a weak filter is applied when a deblocking filter is applied may be provided from an image encoder. The deblocking filter of an image decoder may receive deblocking filter-related information provided from an image encoder and perform deblocking filtering for a corresponding block in an image decoder.

An offset modification unit may perform offset modification on a reconstructed image based on the type of offset modification, offset value information, etc. applied to an image in encoding. An ALF may be applied to a coding unit based on information on whether to apply an ALF, ALF coefficient information, etc. provided from an encoder. Such ALF information may be provided by being included in a specific parameter set.

A memory 245 may store a reconstructed picture or block and use it as a reference picture or a reference block and also provide a reconstructed picture to an output unit.

In the present disclosure, terms may be defined as follows.

A current block (CurrCb) may mean a block to be currently encoded/decoded.

A current picture (CurrPic) may mean a picture including a current block.

The motion vector of a current block (CurrMV) may specify the reference block of the current block within the reference picture (RefPic) of a current block.

A co-located block (ColCb) is a block belonging to a picture different from a current picture, which may mean a block at the same position as the current block. A block at the same position may mean a block including a sample coordinate adjacent to the bottom-right corner of the current block. Alternatively, a block at the same position may mean a block including the center sample coordinate of the current block. However, it is not limited thereto, and a block at the same position may mean a block including the top-left sample coordinate of the current block. Alternatively, a block at the same position may mean a block including a sample coordinate shifted by a predetermined offset vector from the top-left sample coordinate of a current block. Here, an offset vector may be determined based on the motion vector of a spatial neighboring block (e.g., a left neighboring block, a top neighboring block) adjacent to a current block.

A co-located picture (ColPic) may mean a picture including the co-located block. A co-located picture may be any one of a plurality of reference pictures belonging to a reference picture list for inter prediction of the current block. The co-located picture may be included in at least one of a reference picture list in a L0 direction (List0) or a reference picture list in a L1 direction (List1).

The motion vector of a co-located block (ColMV) may specify the reference block of a co-located block within the reference picture of a co-located block (ColRefPic). Alternatively, when a co-located block is a block encoded in an intra block copy mode (IBC mode), the motion vector of a co-located block (ColMV) may mean a block vector that specifies the reference block of a co-located block located within a co-located picture.

The motion information may include at least one of a motion vector, a block vector, a reference picture index or prediction direction information.

FIG. 3 shows a method for performing inter prediction based on temporal motion vector prediction according to the present disclosure.

Referring to FIG. 3, the motion vector of a current block may be obtained based on temporal motion vector prediction. Inter prediction (or, motion compensation) may be performed based on the motion vector of the current block to generate the prediction signal of a current block.

Temporal motion vector prediction according to the present disclosure is a method for deriving the motion vector of a current block by using a feature that a motion at the same position is similar in different pictures.

When the prediction signal of a current block is generated through inter prediction, a candidate list may be generated based on the spatial candidate and/or temporal candidate of a current block. Here, a spatial candidate may be derived from a neighboring block spatially adjacent to a current block (i.e., a spatial neighboring block). A spatial candidate may have motion information of a spatial neighboring block. A temporal candidate may be derived from a neighboring block temporally adjacent to a current block (i.e., a temporal neighboring block). Likewise, a temporal candidate may have motion information of a temporal neighboring block. A temporal candidate may mean a candidate for the temporal motion vector prediction. The temporal neighboring block may correspond to a co-located block.

The motion information of a co-located block for temporal motion vector prediction may be confirmed. When a co-located block is a block encoded in an inter mode (i.e., when a co-located block has motion information), the motion vector of a current block may be derived based on the motion vector of a corresponding co-located block. As an example, the motion vector of a co-located block may be configured as the motion vector of a current block. Alternatively, the motion vector of a co-located block may be modified based on at least one of reference picture information of a co-located block or reference picture information of a current block, and a modified motion vector may be configured as the motion vector of a current block. Here, reference picture information may include at least one of the picture order count(POC) of a reference picture, a reference picture index or whether a reference picture is a long-term reference picture. On the other hand, when a co-located block is not a block encoded in an inter mode, temporal motion vector prediction may not be used.

Alternatively, temporal motion vector prediction may also be used for sub-block-based temporal motion vector prediction. Sub-block-based temporal motion vector prediction may mean a method for performing inter prediction in the unit of a sub-block by using motion vectors corresponding to the position of a reference block among the motion vectors stored in the motion information buffer of a reference picture. Here, the reference picture may mean a co-located picture including a co-located block. A co-located block may be specified based on the motion vector of a spatial neighboring block adjacent to a current block.

The reference block may be partitioned into a plurality of sub-blocks, and it may be checked whether a motion vector exists in the unit of a sub-block. When a motion vector exists in a sub-block within a reference block, inter prediction may be performed based on the motion vector of a corresponding sub-block to generate the prediction signal of a sub-block within a current block corresponding to a corresponding sub-block. On the other hand, when a motion vector does not exist in a sub-block within a reference block, inter prediction may be performed based on the motion vector of a spatial neighboring block adjacent to the current block to generate the prediction signal of a sub-block within a current block corresponding to a corresponding sub-block. Alternatively, when a motion vector does not exist in a sub-block within a reference block, inter prediction may be performed based on the motion vector of another sub-block within a reference block. Here, another sub-block may be a sub-block including a center sample coordinate within a reference block.

In FIG. 3, CurPic, ColPic, ColRefPic and RefPic may mean a current picture, a co-located picture including a co-located block for temporal motion vector prediction, the reference picture of a co-located block and the reference picture of a current block, respectively. CurCb and ColCb may mean a current block and a co-located block, respectively. CurMV and ColMV may mean the motion vector of a current block and the motion vector of a co-located block, respectively. Here, the motion vector of a current block may be derived through temporal motion vector prediction.

Information on a co-located picture may be obtained from at least one of a sequence parameter set (SPS), a picture parameter set (PPS), a picture header (PH) or a slice header (SH). Any one of a plurality of reference pictures belonging to a reference picture list may be determined based on information on the co-located picture, and the determined reference picture may be used as a co-located picture. Information on a co-located picture may include at least one of a co-located picture index, a flag representing whether a co-located picture belongs to a reference picture list in a L0 direction or a flag representing whether a co-located picture belongs to a reference picture list in a L1 direction.

An encoder may determine picture P or B in a reference picture list as a co-located picture for temporal motion vector prediction, and encode information on a co-located picture for specifying it.

In order to reduce the size of a motion information buffer, the motion information of a co-located block may be sampled in a unit of a specific block size and stored in a motion information buffer. In this case, a specific block size may be a square block such as 4×4, 8×8 or 16×16. Alternatively, it may be a non-square block such as N×M. Here, N and M may be any one of the square numbers of 2.

In addition, in order to further reduce the size of a motion information buffer, a motion vector may be compressed and stored in a motion information buffer. When a motion vector is compressed and stored, a motion vector may be reconstructed by performing the reverse process of a compression method on a stored motion vector.

The compression method of a motion vector may express a motion vector with a smaller number of bits. As an example, when the x-axis and y-axis sizes of a current motion vector are expressed in 18 bits, the size of x-axis and y-axis motion vectors may be expressed in 10 bits. In this case, a motion vector expressed in 10 bits may be expressed as a fixed-point. When a motion vector is expressed as a fixed-point, compression may be performed by shifting it to the right by a difference between the original number of bits and the number of compressed bits. Alternatively, a motion vector expressed in 10 bits may be expressed as a floating-point. When a motion vector is expressed as a floating-point, 6 bits out of 10 bits may mean a signed mantissa and the remaining 4 bits out of 10 bits may mean an exponent. The number of bits for expressing an exponent may be less than the number of bits for expressing a mantissa.

The number of bits of a compressed motion vector may be determined based on the type of a current picture or a slice. As an example, when a current picture or a slice may use only intra prediction, a block vector may be stored instead of a motion vector at the position of a block encoded in an IBC mode. Since a block vector may be expressed in a smaller size than a motion vector, it may be expressed with a smaller number of bits in compression. The number of bits for expressing a compressed block vector may be determined based on the size of a coding/decoding unit. Here, a size may be defined as a width, a height, the product of a width and a height, the maximum/minimum value of a width and a height, etc. A coding/decoding unit may be one of a picture, a tile, a slice, a coding tree unit (CTU) or a virtual pipeline data unit (VPDU). An IBC mode may be a method for generating a prediction signal by using a reference block that belongs to a pre-reconstructed region within the same picture as a current block and is specified by a block vector.

Alternatively, the block vector of a block encoded in an IBC mode may be stored in a motion information (or motion field) buffer. As an example, a block vector may be stored in the same motion information buffer as the motion vector of a block encoded in an inter mode. Alternatively, a block vector may be stored in a motion information buffer different from the motion vector of a block encoded in an inter mode. In this case, a motion information buffer may be referred to as a block vector buffer.

A block vector may be compressed and stored in a motion information buffer. Alternatively, when a co-located block for temporal motion vector prediction (or sub-block-based temporal motion vector prediction) is a block encoded in an IBC mode, a corresponding co-located block may have a block vector. The block vector of a co-located block may be added to a candidate list and used to derive the motion vector of a current block. The block vector of a co-located block may be compressed and stored in a motion information buffer. As an example, a block vector may be compressed with precision different from a motion vector for other inter modes. The precision of a block vector may be 1/N, and N may be any one of 2, 4, 8 and 16.

In temporal motion vector prediction, information of a co-located block corresponding to a current block within a co-located picture may be checked first to predict the motion vector of a current block.

When a co-located block is encoded in an intra mode, an IBC mode or a pallete mode, temporal motion vector prediction may not be performed based on a corresponding co-located block. On the other hand, when a co-located block is not encoded in an intra mode, an IBC mode or a pallete mode, temporal motion vector prediction may be performed based on a corresponding co-located block, and the motion vector of a current block may be derived based on the motion vector of a co-located block.

When temporal motion vector prediction is performed, the motion vector of the current block may be scaled based on at least one of a POC difference (curPocDiff) between a current picture and the reference picture of a current block or a POC difference (colPocDiff) between a co-located picture and the reference picture of a co-located block.

When the reference picture of a co-located block is a long-term reference picture, or when curPocDiff and colPocDiff are the same, scaling for the motion vector of a current block may be omitted.

Inter prediction may be performed based on the motion vector of a current block to generate the prediction signal of a current block.

FIG. 4 shows a method for performing inter prediction based on temporal motion vector prediction when a co-located block is a block encoded in an IBC mode.

In temporal motion vector prediction according to the present disclosure, when a co-located block is a block encoded in an IBC mode, the block vector of a co-located block may be used for temporal motion vector prediction in the same manner as a motion vector. As an example, temporal motion vector prediction may be allowed in the next picture immediately after picture I is reconstructed. In this case, a co-located block or the motion information (or motion vector) of a co-located block may be added to a candidate list as a merge candidate or an AMVP candidate. Alternatively, the block vector of a co-located block may be used for temporal motion vector prediction in a sub-block unit.

Not only the motion vector of a block encoded in an inter mode, but also the block vector of a block encoded in an IBC mode may be stored in a motion information buffer (motion field). When the co-located block of a current block is not only a block encoded in an IBC mode, but also a block encoded in an inter mode, a co-located block or the motion information of a co-located block may be used as a temporal candidate.

The accuracy of prediction may be improved by increasing the number of candidates included in a candidate list. In other words, the number of temporal candidates that may be added to a candidate list may also increase. For a block encoded in an IBC mode as well as for a block encoded in an inter mode, a block vector may be considered as a temporal candidate, and such diverse temporal motion information may be used to increase the accuracy of prediction and improve compression performance.

In FIG. 4, CurPic and ColPic may mean a current picture and a co-located picture including a co-located block for temporal motion vector prediction, respectively. CurCb and ColCb may mean a current block and a co-located block, respectively. CurMV and ColMV may mean the motion vector of a current block and the motion vector of a co-located block, respectively. Here, the motion vector of a current block may be derived through temporal motion vector prediction.

Information on a co-located picture may be obtained from at least one of a sequence parameter set (SPS), a picture parameter set (PPS), a picture header (PH) or a slice header (SH). Any one of a plurality of reference pictures belonging to a reference picture list may be determined based on information on the co-located picture, and the determined reference picture may be used as a co-located picture. Information on a co-located picture may include at least one of a co-located picture index, a flag representing whether a co-located picture belongs to a reference picture list in a L0 direction or a flag representing whether a co-located picture belongs to a reference picture list in a L1 direction.

An encoder may determine picture P or B in a reference picture list as a co-located picture for temporal motion vector prediction, and encode information on a co-located picture for specifying it.

In temporal motion vector prediction, information of a co-located block corresponding to a current block within a co-located picture may be checked first to predict the motion vector of a current block.

When a co-located block is encoded in an intra mode or a pallete mode, temporal motion vector prediction may not be performed based on a corresponding co-located block. On the other hand, when a co-located block is encoded in an IBC mode or an inter mode, temporal motion vector prediction may be performed based on a corresponding co-located block, and the motion vector of a current block may be derived based on the block vector or the motion vector of a co-located block.

Alternatively, when a co-located block is encoded by template matching-based intra prediction, a vector representing a position difference between a co-located block and a reference block for template matching may be derived as a block vector. The motion vector of a current block may be derived based on the derived block vector.

The template matching-based intra prediction may mean a prediction method for calculating a cost between template regions and specifying a reference block within a search range based on the cost. A search range may be defined within a reconstructed region within a current picture. In other words, a search range may be all or a part of the reconstructed region within a current picture. A region with the smallest cost within a search range may be found, and a block having a corresponding region as a template region may be specified as a reference block.

When temporal motion vector prediction is allowed/applied to a current block, the reference picture of a current block may be substituted with a co-located picture. When temporal motion vector prediction is allowed/applied, it may mean that the motion vector of a current block is derived based on a temporal candidate or may mean that a temporal candidate is added to the candidate list of a current block.

Inter prediction may be performed based on the motion vector of a current block to generate the prediction signal of a current block.

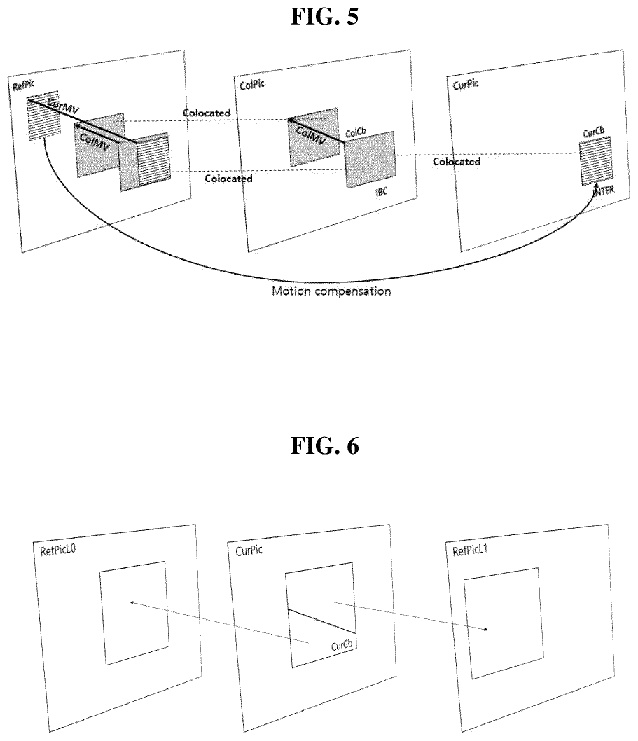

FIG. 5 shows a method for performing inter prediction based on temporal motion vector prediction when a co-located block is a block encoded in an IBC mode.

Referring to FIG. 5, when a co-located block is a block encoded in an IBC mode, the motion vector of a current block may be derived by scaling the block vector of a corresponding block, and inter prediction may be performed based on a derived motion vector.

In FIG. 5, CurPic, ColPic and RefPic may mean a current picture, a co-located picture including a co-located block for temporal motion vector prediction and the reference picture of a current block, respectively. CurCb and ColCb may mean a current block and a co-located block, respectively. CurMV and ColMV may mean the motion vector of a current block and the motion vector of a co-located block, respectively. Here, the motion vector of a current block may be derived through temporal motion vector prediction.

Information on a co-located picture may be obtained from at least one of a sequence parameter set (SPS), a picture parameter set (PPS), a picture header (PH) or a slice header (SH). Any one of a plurality of reference pictures belonging to a reference picture list may be determined based on information on the co-located picture, and the determined reference picture may be used as a co-located picture. Information on a co-located picture may include at least one of a co-located picture index, a flag representing whether a co-located picture belongs to a reference picture list in a L0 direction or a flag representing whether a co-located picture belongs to a reference picture list in a L1 direction.

An encoder may determine picture I, P or B in a reference picture list as a co-located picture for temporal motion vector prediction, and encode information on a co-located picture for specifying it.

In temporal motion vector prediction, information of a co-located block corresponding to a current block within a co-located picture may be checked first to predict the motion vector of a current block.

When a co-located block is encoded in an intra mode or a pallete mode, temporal motion vector prediction may not be performed based on a corresponding co-located block. On the other hand, when a co-located block is encoded in an IBC mode or an inter mode, temporal motion vector prediction may be performed based on a corresponding co-located block. The motion vector of a current block may be derived based on the block vector or the motion vector of a co-located block.

Alternatively, when a co-located block is encoded by template matching-based intra prediction, a vector representing a position difference between a co-located block and a reference block for template matching may be derived as a block vector. The motion vector of a current block may be derived based on the derived block vector.

In addition, the derived motion vector may be scaled based on a predetermined scaling factor. Here, a scaling factor may be derived based on at least one of a POC difference (curPocDiff) between a current picture and the reference picture of a current block or a POC difference (colPocDiff) between a co-located picture and the reference picture of a current block. In this case, when curPocDiff and colPocDiff are the same, scaling for a motion vector may be omitted.

The prediction signal of a current block may be generated by performing inter prediction based on a motion vector derived or scaled for a current block.

When a co-located block is encoded in an inter mode, inter prediction may be performed based on a method according to FIG. 3 described above, and when a co-located block is encoded in an IBC mode, inter prediction may be performed based on a method according to FIG. 4 or FIG. 5 described above.

FIG. 6 shows a geometric partitioning-based prediction method according to the present disclosure.

A geometric partitioning-based prediction method may be any one of the pre-defined inter prediction modes. According to a geometric partitioning-based prediction method, prediction blocks may be generated from reference pictures of a current block, and a final prediction block may be generated through the weighted sum of prediction blocks.

Based on predetermined geometric partitioning information, a current block may be partitioned into two partitions, i.e., the first partition and the second partition. The first prediction block for the first partition may be generated, and the second prediction block for the second partition may be generated. Here, when the first partition has unidirectional prediction information, the first prediction block may be a block generated through unidirectional prediction. Alternatively, when the first partition has bidirectional prediction information, the first prediction block may be a block generated through bidirectional prediction. Similarly, when the second partition has unidirectional prediction information, the second prediction block may be a block generated through unidirectional prediction. Alternatively, when the second partition has bidirectional prediction information, the second prediction block may be a block generated through bidirectional prediction. Alternatively, both the first and second partitions may be restricted to have only unidirectional prediction information.

The final prediction block of a current block may be generated through the weighted sum between the first prediction block and the second prediction block. In this case, for the weighted sum, a mask defining a weight for each sample position within a prediction block may be used. The mask may be determined for each of the two prediction blocks. The weight may be determined based on geometric partitioning information.

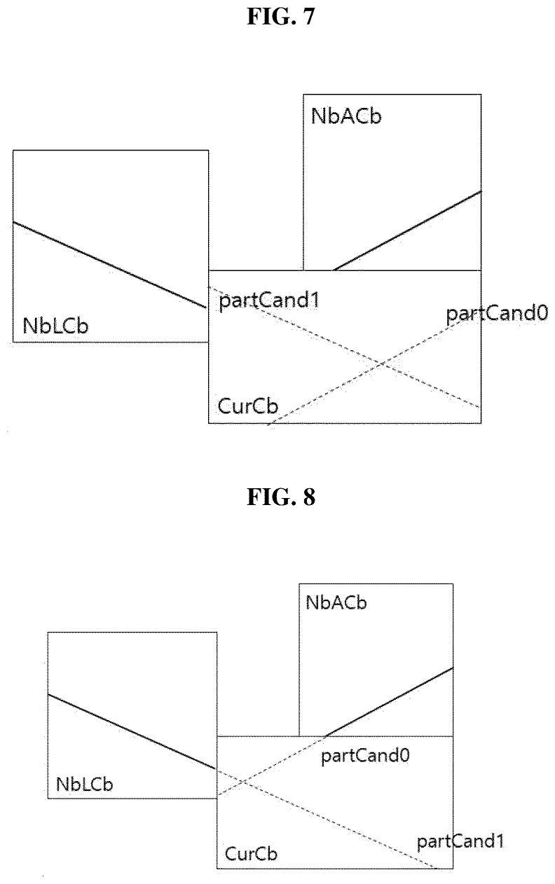

The geometric partitioning information according to the present disclosure may be information for partitioning a current block into two partitions by using one straight line. As an example, geometric partitioning information may include at least one of distance information representing a distance between a partitioning straight line and the center of a current block or angle information representing the angle of a partitioning straight line. A weight for the weighted sum may be determined based on at least one of angle information or distance information described above. The angle information and the distance information may be defined in the form of an index, respectively. A method for predicting/deriving the geometric partitioning information will be described in detail by referring to FIGS. 7 to 12.

Alternatively, geometric partitioning information may be defined as one index. A mask that is pre-defined equally for an encoder and a decoder may be used according to a corresponding index. The mask may be determined for each of the two prediction blocks.

The above-described mask may be defined/determined for each of the partitioning straight lines available for geometric partitioning. Alternatively, a mask may be defined/determined only for a part of the available partitioning straight lines, and a mask for the remaining partitioning straight line(s) may be derived based on the mask for the part. As an example, a mask for any one of the remaining partitioning straight lines may be derived by rotating any one of the masks for the part by a predetermined angle (e.g., 45 degrees, 90 degrees, 135 degrees or 180 degrees). Alternatively, a mask for any one of the remaining partitioning straight lines may be derived by inverting any one of the masks for the part.

A flag for using a rotated mask may be encoded in an encoding apparatus and transmitted to a decoding apparatus. A flag for using an inverted mask may be encoded in an encoding apparatus and transmitted to a decoding apparatus. The flag may be encoded in the unit of a coding block. The flag may indicate whether to use a rotated mask. The flag may indicate whether to use an inverted mask.

FIG. 7 shows a method for predicting geometric partitioning information according to the present disclosure.

The geometric partitioning information of a current block may be predicted based on the geometric partitioning information of a neighboring block adjacent to a current block.

In FIG. 7, CurCb may be a block that tries to perform current prediction (i.e., a current block), and NbLCb and NbACb may be a block that performed geometric partitioning-based prediction among the blocks adjacent to the left of a current block and a block that performed geometric partitioning-based prediction among the blocks adjacent to the top of a current block, respectively. partCand0 may be used as the geometric partitioning information candidate of a current block as the geometric partitioning information of NbACb. And, partCand1 may be used as the geometric partitioning information candidate of a current block as the geometric partitioning information of NbLCb.

Blocks using geometric partitioning-based prediction among the neighboring blocks of a current block may be searched. When at least one neighboring block uses geometric partitioning-based prediction, the geometric partitioning information of a current block may be predicted based on the geometric partitioning information of a neighboring block.

One or any one of the multiple geometric partitioning information candidates may be configured as the geometric partitioning information of a current block. For this purpose, an index specifying any one of the geometric partitioning information candidates may be used. The index may be signaled through a bitstream. The index may be signaled in the unit of a block (e.g., a coding block).

FIG. 8 shows a method for predicting geometric partitioning information according to the present disclosure.

Blocks using geometric partitioning-based prediction among the neighboring blocks of a current block may be searched. When at least one neighboring block uses geometric partitioning-based prediction, the geometric partitioning information of a current block may be predicted based on the geometric partitioning information of a neighboring block.

Specifically, the partitioning straight line of a neighboring block according to the geometric partitioning information of a neighboring block may be extended to a current block, and geometric partitioning information corresponding to an extended partitioning straight line may be used as the geometric partitioning information candidate of a current block. Through this process, one or multiple geometric partitioning information candidates may be derived.

One or any one of the multiple geometric partitioning information candidates may be configured as the geometric partitioning information of a current block. For this purpose, an index specifying any one of the geometric partitioning information candidates may be used. The index may be signaled through a bitstream. The index may be signaled in the unit of a block (e.g., a coding block).

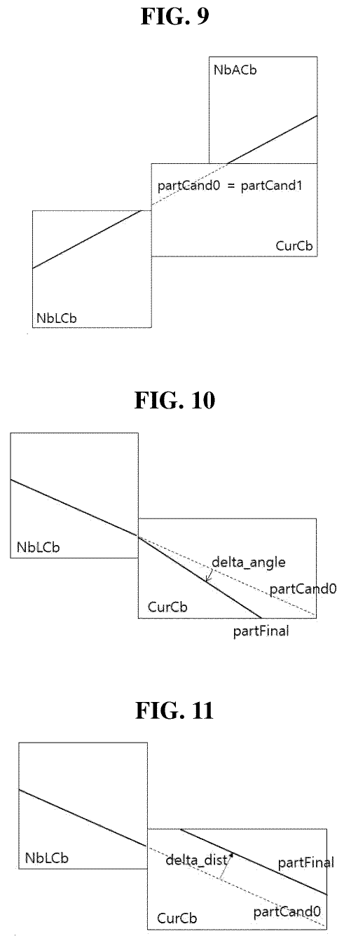

FIG. 9 shows a method for predicting geometric partitioning information according to the present disclosure.

FIG. 9 relates to a method for predicting geometric partitioning information when the angles of partitioning straight lines for geometric partitioning of neighboring blocks are the same.

Blocks using geometric partitioning-based prediction among the neighboring blocks of a current block may be searched. When at least one neighboring block uses geometric partitioning-based prediction, the geometric partitioning information of a current block may be predicted based on the geometric partitioning information of a neighboring block.

Specifically, the partitioning straight line of a neighboring block according to the geometric partitioning information of a neighboring block may be extended to a current block, and geometric partitioning information corresponding to an extended partitioning straight line may be used as the geometric partitioning information candidate of a current block. Through this process, one or multiple geometric partitioning information candidates may be derived.

As shown in FIG. 9, when the angles of partitioning straight lines according to at least two geometric partitioning information candidates are the same, a corresponding geometric partitioning information candidate may be used as the geometric partitioning information of a current block. In this case, signaling of an index specifying any one of the geometric partitioning information candidates may be omitted.

FIGS. 10 and 11 show a method for deriving geometric partitioning information according to the present disclosure.

In FIGS. 10 and 11, partCand0 may mean geometric partitioning information of a current block predicted based on geometric partitioning information of a neighboring block. Here, the prediction of geometric partitioning information is based on any one of the prediction methods described by referring to FIGS. 7 to 9.

The predicted geometric partitioning information may be modified based on at least one of predetermined delta angle information (delta_angle) or delta distance information (delta_distance), and modified geometric partitioning information may be configured as the final geometric partitioning information of a current block.

The delta angle information may include at least one of the absolute value information of a delta angle or the sign information of a delta angle. The absolute value information of a delta angle may represent the size of the rotation angle of a predicted partitioning straight line according to predicted geometric partitioning information. The sign information of a delta angle may represent the rotation direction of a predicted partitioning straight line. The delta distance information may include at least one of the absolute value information of a delta distance or the sign information of a delta distance. The absolute value information of a delta distance may represent the size of the movement distance of a predicted partitioning straight line. The sign information of a delta distance may represent the movement direction of a predicted partitioning straight line. At least one of the delta angle information or the delta distance information may be signaled through a bitstream.

Delta angle information may be an angle based on the predicted partitioning straight line. An encoding apparatus may determine a delta angle that generates a prediction block with the smallest error among a variety of delta angles, and encode and signal it. Similarly, delta distance information may be a distance based on the predicted partitioning straight line. An encoding apparatus may determine a delta distance that generates a prediction block with the smallest error among a variety of delta distances, and encode and signal it.

Delta angle information and/or delta distance information may be quantized into a specific number of bits. In this case, the number of bits may be signaled from an encoding apparatus through at least one of a sequence parameter set (SPS), a picture parameter set (PPS), a picture header (PH) or a slice header (SH).

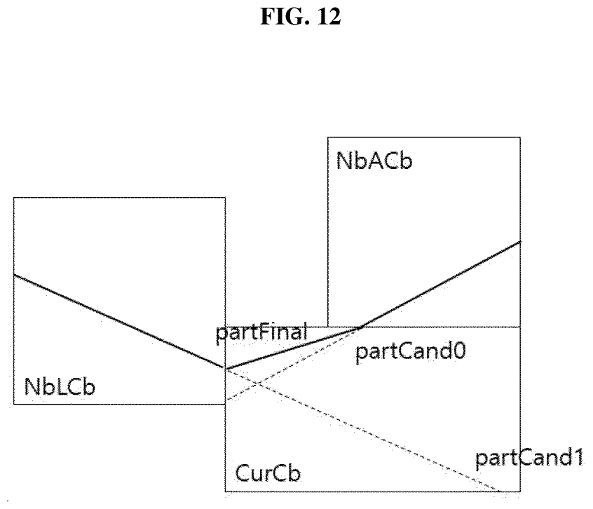

FIG. 12 shows a method for predicting geometric partitioning information according to the present disclosure.

Blocks using geometric partitioning-based prediction among the neighboring blocks of a current block may be searched. When at least one neighboring block uses geometric partitioning-based prediction, the geometric partitioning information of a current block may be predicted based on the geometric partitioning information of a neighboring block.

Specifically, the partitioning straight line of a neighboring block according to the geometric partitioning information of a neighboring block may be extended to a current block, and geometric partitioning information corresponding to an extended partitioning straight line may be used as the geometric partitioning information candidate of a current block. Through this process, one or multiple geometric partitioning information candidates may be derived.

As shown in FIG. 12, there may be a case where partitioning straight lines according to multiple geometric partitioning information candidates intersect each other. In this case, the geometric partitioning information of a current block may be derived based on the first position where a partitioning straight line according to the geometric partitioning information of NbACb intersects a current block and the second position where a partitioning straight line according to the geometric partitioning information of NbLCb intersects a current block.

The various embodiments of the present disclosure do not list all possible combinations, but are intended to describe the representative aspect of the present disclosure, and matters described in various embodiments may be applied independently or in a combination of at least two.

In addition, the various embodiments of the present disclosure may be implemented by hardware, firmware, software or a combination thereof. For implementation by hardware, they may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

The range of the present disclosure includes software or machine-executable instructions (i.e., an operating system, an application, firmware, a program, etc.) that enable operations according to the methods of various embodiments to be executed on a device or computer, and a non-transitory computer-readable medium in which such software or instructions are stored and executable on a device or computer.

1. An image decoding method, comprising:
determining a co-located block for temporal motion vector prediction of a current block;
deriving a block vector from the co-located block;
deriving a motion vector of the current block based on the block vector; and
generating a prediction signal of the current block by performing inter prediction based on the motion vector of the current block.

2. The method of claim 1, wherein the co-located block is a block encoded in an intra block copy (IBC) mode.

3. The method of claim 1, wherein the co-located block is a block encoded in a template matching-based intra mode.

4. The method of claim 3, wherein the block vector is derived based on a position difference between the co-located block and a reference block for the template matching of the co-located block.

5. The method of claim 1, wherein a reference picture of the current block is substituted with a co-located picture to which the co-located block belongs.

6. The method of claim 1, wherein the motion vector of the current block is derived by applying a predetermined scaling factor to the block vector, and
wherein the scaling factor is derived based on at least one of a first picture order count (POC) difference between a current picture to which the current block belongs and a reference picture of the current block or a second POC difference between a co-located picture to which the co-located block belongs and the reference picture of the current block.

7. An image encoding method, comprising:
determining a co-located block for temporal motion vector prediction of a current block;
deriving a block vector from the co-located block;
deriving a motion vector of the current block based on the block vector; and
generating a prediction signal of the current block by performing inter prediction based on the motion vector of the current block.

8. A method for transmitting image data, comprising:
determining a co-located block for temporal motion vector prediction of a current block;
deriving a block vector from the co-located block;
deriving a motion vector of the current block based on the block vector;
generating a prediction signal of the current block by performing inter prediction based on the motion vector of the current block;
deriving a residual signal of the current block based on the prediction signal;
generating a bitstream by encoding the residual signal; and
transmitting the image data including the bitstream.
